(19) United States
(12) Patent Application Publication
(10) Pub. No.: US 2005/0268502 A1
(43) Pub. Date: Dec. 8, 2005

(54) Calendar device with tabbed photo sleeve

(76) Inventor: C. Bennett Blakeney, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 10/862,848

(22) Filed: Jun. 7, 2004

(51) Int. Cl. G09D 3/02

(52) U.S. Cl. 40/122

(57) ABSTRACT

A calendar device for storing and displaying interchangeable photographs or pictures and reminding a user of important events includes: (a) a photo sleeve portion including at least one durable, reusable, re-foldable tab; and (b) a calendar portion adjacent to the photo sleeve portion; wherein the photo sleeve portion holds at least one photograph or picture.

### CROSS REFERENCE TO RELATED DOCUMENT

This invention was described in Disclosure Document Number 548495, which was received by the U.S. Patent & Trademark Office on Mar. 8, 2004.

### BACKGROUND OF THE INVENTION

1. Technical Field

The present invention relates to a calendar device for displaying and/or storing interchangeable photographs or pictures within a photo sleeve of the device, more particularly, a calendar device with a photo sleeve portion comprising at least one re-foldable side tab.

2. Background Information

Calendars serve both practical and aesthetic purposes. Calendars are used to record important upcoming events, such as meetings, appointments, birthdays, anniversaries, parties, and other special occasions, for future reference. Users often jot notes on calendars to remind the user to attend future events and special occasions, or to send commemorative cards and presents to relatives and friends on birthdays, anniversaries, etc. Many calendars include a pre-determined, printed picture for decoration, which is displayed adjacent to a monthly calendar portion.

Many calendar users would rather display personal photographs or pictures than view a canned picture for a month. Some existing calendar devices provide a means for a user to display photographs. These calendar devices allow users to display photographs or pictures related to important events in conjunction with calendars denoting the same important events, which reminds the users to attend or otherwise recognize the important events. However, these existing calendar devices often lack a quick, reliable means of securing the photographs and pictures in place, or a means of retaining the photographs and pictures without damaging them. Since the photographs cannot be changed quickly, the user is discouraged from doing so, and he or she becomes inured to the photograph that remains displayed for long periods in the device. Such calendar devices lack adequate storage for additional photographs or pictures for future display. Also, most traditional calendars are limited in their usefulness in that, although the user may circle a date as a reminder, no space is provided to write down special events. Thus, there is a need for a calendar device which concurrently:
1) allows the user to exhibit, store, and quickly interchange photographs or pictures, so the calendar is personalized;
2) retains the interchangeable photographs or pictures in place without damaging them; and
3) reminds the user of important events and special occasions, and allows the user to write down notes.

### BRIEF SUMMARY OF THE INVENTION

The present invention is a calendar device for storing and displaying interchangeable photographs or pictures, and reminding a user of important events. The calendar device includes: (a) a photo sleeve portion comprising at least one reusable, re-foldable tab for retaining at least two photographs or pictures in the photo sleeve portion; and (b) a calendar portion adjacent to the photo sleeve portion.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a front elevational view of a calendar device according to the present invention, shown in use with a tab in a folded position;

FIG. 2 is a front elevational view of a calendar device according to the present invention, shown in use with a tab in an extended position;

FIG. 3A is a front elevational view of a photo sleeve of a calendar device according to the present invention, shown with several pictures extending from the photo sleeve;

FIG. 3B is a bottom plan view of a photo sleeve of a calendar device according to FIG. 3A;

FIG. 4 is a front elevational view of a photo sleeve of a calendar device according to the present invention, shown with two tabs in an extended position;

FIG. 5 is a front elevational view of a photo sleeve of a calendar device according to the present invention, shown with two tabs in an extended position;

FIG. 6 is a front elevational view of a photo sleeve of a calendar device according to the present invention, showing layers of the photo sleeve “peeled-away” for purposes of illustration;

FIG. 7 is a front elevational view of a cover of a calendar device according to the present invention;

FIG. 8 is a front elevational view of a calendar device according to the present invention, shown with a split tab in an extended position;

FIG. 9 is a front elevational view of a photo sleeve of a calendar device, showing a double tab and layers of the photo sleeve “peeled-away”;

FIG. 10 is a front elevational view of a photo sleeve of a calendar device according to the present invention, shown with lower tabs in an extended position;

FIG. 11 is a front elevational view of a photo sleeve of a calendar device according to the present invention, shown with an upper tab in an extended position; and

FIG. 12 is a front elevational view of a photo sleeve of a calendar device according to the present invention, shown with irregular-edged tabs in an extended position.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

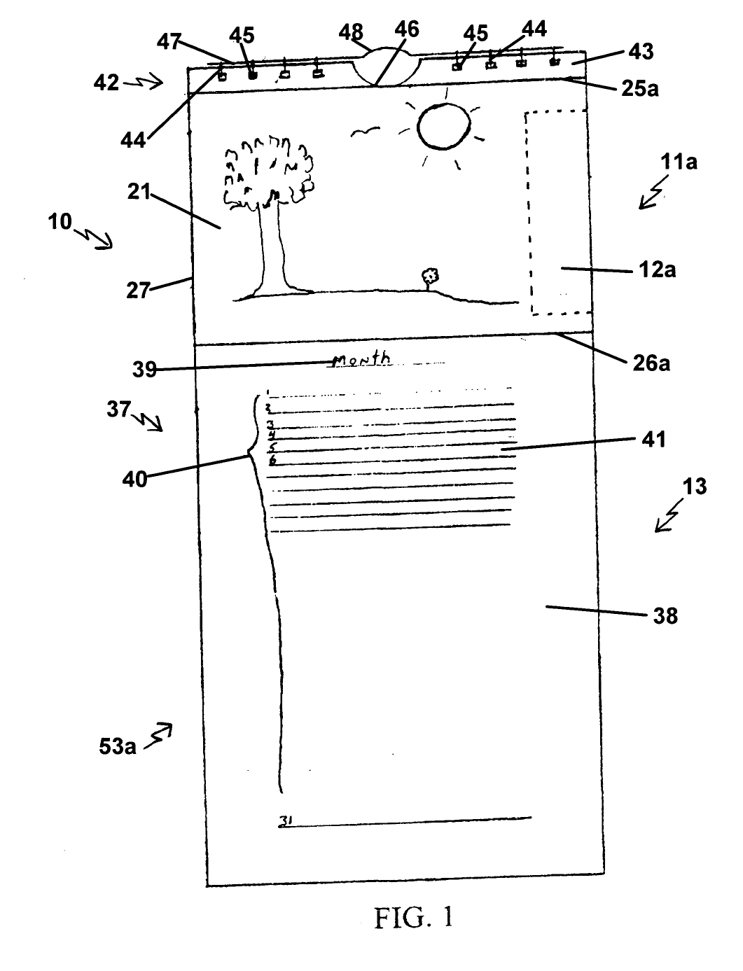

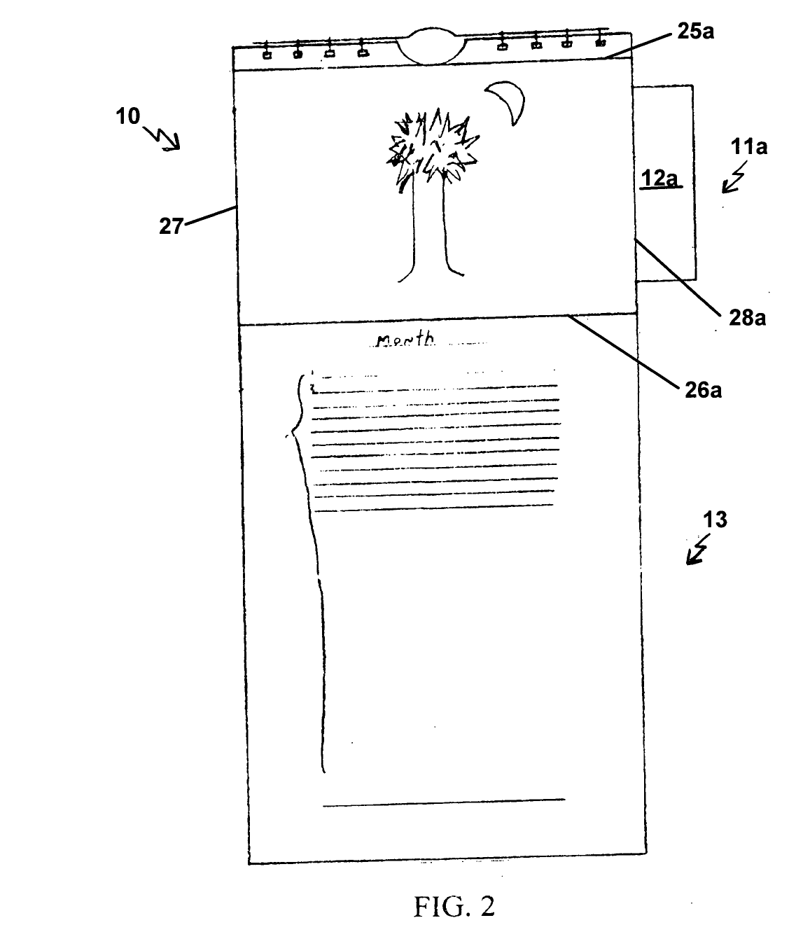

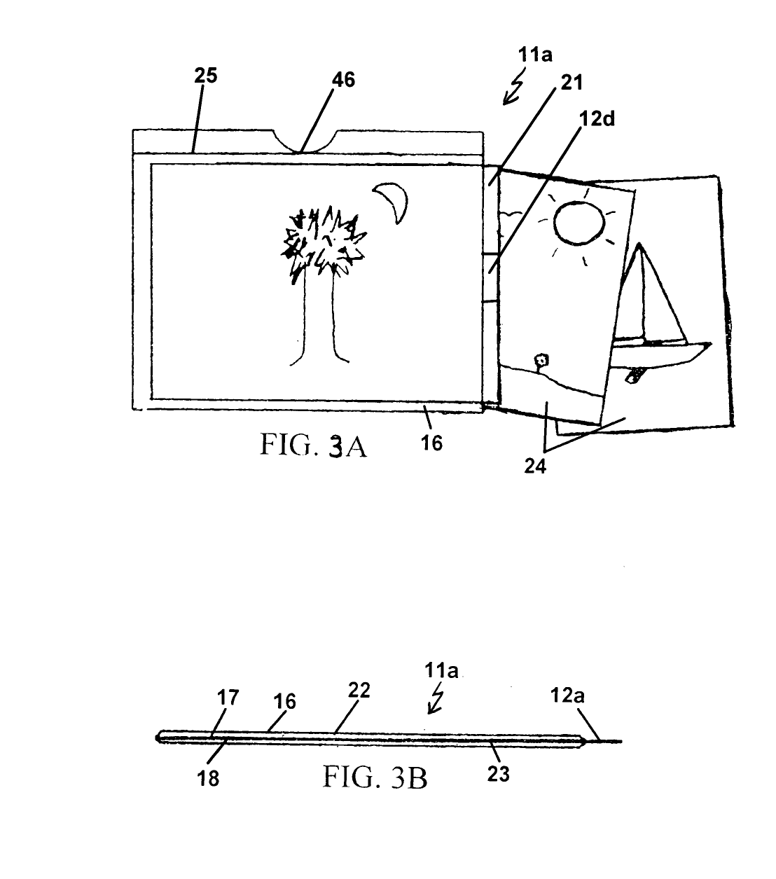

Turning first to FIGS. 1 and 2, a calendar device 10 according to a first embodiment of the present invention comprises: a) a photo sleeve portion 11 for displaying a photograph or picture 21 of choice; and b) a calendar portion 13 adjacent to, and preferably below, the photo sleeve portion 11. The photo sleeve portion 11 also retains extra, stored photographs or pictures 24 behind the displayed photograph or picture 21 (see FIG. 3A).

In the preferred embodiment shown in FIGS. 1 and 2, the photo sleeve portion 11 is generally rectangular in shape, and the length and width dimensions of the photo sleeve portion 11 are approximately equal to the dimensions of a standard photograph (e.g., 4 inches×6 inches). The calendar portion 13 is also generally rectangular in shape, with its width being approximately equal to the width of the photo sleeve portion 11. A top edge 25, a bottom edge 26 adjacent the calendar portion 13, and a side edge 27 of the photo sleeve portion 11 are sealed. The displayed photograph or picture 21 and additional photographs or pictures 24 are removably receivable in the photo sleeve portion 11 through an open side edge 28 of the photo sleeve. A foldable photo tab 12 extending from the open edge 28 is for securing the displayed photograph or picture 21, as well as any stored photographs or pictures 24, within the photo sleeve portion 11.

The calendar device 10 preferably comprises twelve pages 53 (or six pages printed back and front), one for each month of the year. In one embodiment, the calendar portion 13 is detachable from the photo sleeve portion 11a, so that each calendar device 10 includes one photo sleeve portion 11a and twelve attachable monthly calendar pages. At the end of each month, the user detaches the calendar page for that month and attaches the calendar page for the next month. In an alternate embodiment, each calendar page 53 has its own photo sleeve portion 11a and calendar portion 13 (see FIG. 1).

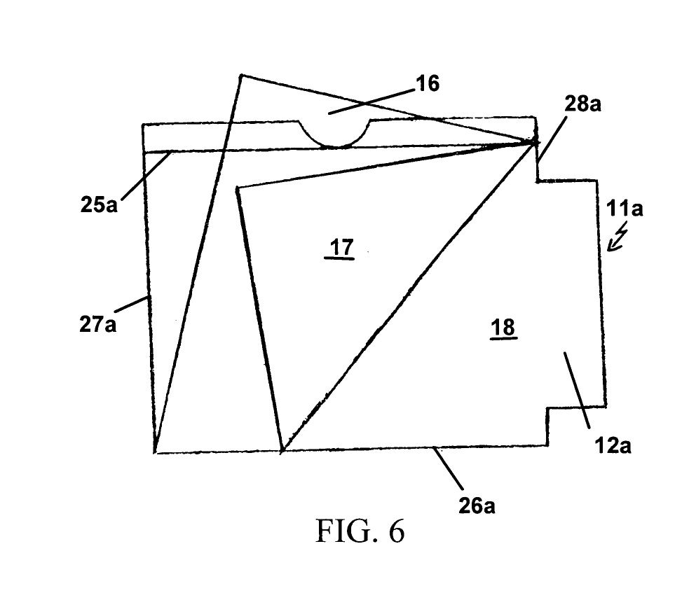

Referring to FIGS. 3A, 3B, and 6, a transparent front sheet 16 of the photo sleeve portion 11 protects and exhibits the displayed photograph or picture 21. In this preferred embodiment of the present invention, the photo sleeve portion 11 includes a front pocket 22 for displaying the photograph or picture 21 of choice, and a rear pocket 23 directly behind the front pocket 22 for storing extra photographs or pictures 24 for future display. The first pocket 22 lies between the transparent front sheet 16 and a dividing sheet 17, while the second pocket 23 lies between the dividing sheet 17 and a rear sheet 18. Thus, the photo sleeve comprises three layers: the transparent front sheet 16, dividing sheet 17, and rear sheet 18. The front sheet 16 is transparent in order to facilitate viewing of the displayed photograph or picture 21. The dividing sheet 17 is preferably opaque or colored, so that it borders the displayed photograph/ picture 21 (like a matte) and hides the stored photographs/pictures 24 in the event that the length and/or width of the displayed photograph or picture 21 is smaller than the length and/or width of the photo sleeve portion 11, or any of the stored photographs or pictures 24.

With continued attention to FIGS. 3A, 3B, and 6, the transparent front sheet 16, the dividing sheet 17, and the rear sheet 18 are joined, in that order, from the front side to the back side of the photo sleeve portion 11, along the side edge 27, and along the top and bottom edges 25, 26. The sheets 16, 17, 18 are not connected along the opposite side edge 28. Thus, in use, the displayed photograph or picture 21 is removably insertable in the front pocket 22 through the open edge 28, and extra photographs or pictures 24 are removably insertable in the rear pocket 23, also through the open edge 28. In this first embodiment, the depth of the front pocket 22 is sufficient to hold only one displayed photograph or picture 21. However, the depth of the rear pocket 23 is sufficient to hold a stack of at least two, and more preferably four to six, stored photographs or pictures 24.

The rear pocket 23 may also be pleated so that it is accordion-like in order to store a larger stack of stored photographs or pictures 24 for selection.

As shown in FIGS. 3B and 6, the foldable and re-foldable side tab 12 projects from the rear sheet 18 at the open edge 28. This reusable side tab 12 may be integral with the rear sheet 18, or it may be separately adhered to the rear sheet 18. In this embodiment, the side tab 12 is generally rectangular in shape and extends almost the entire length of the photo sleeve portion 11. The tab 12 is made from a durable, lightweight, easily folded material.

In use, as illustrated in FIG. 1, the tab 12 is folded at open edge 28, and inserted into the photo sleeve portion 11 through the open edge 28. The lightweight folded tab is held between the transparent front sheet 16 and the displayed photograph or picture 21 by the weight of the other photos/pictures and the calendar pages. In this folded position, the side tab 12 retains both the displayed photograph or picture 21 and any stored photographs or pictures 24 within the photo sleeve portion 11. The side tab 12 is preferably made of a transparent material, so that no part of the displayed photograph or picture 21 is blocked from view when the tab 12 is in its folded position.

To change the displayed photograph or picture 21, the user pulls the side tab 12 out from the photo sleeve portion 11, unfolding it so that it projects from the open end 28 of the photo sleeve as shown in FIG. 2. The open end 28 and side tab 12 may be on the right (shown) or the left side of the photo sleeve. Then the user uses his or her forefinger and thumb to remove the displayed photograph or picture 21 from the front pocket 22 through the open end 28. The user next removes a stored photograph or picture 24 from the rear pocket 23 through the open end 28 and inserts it through the open end 28 into the front pocket 22 in place of the previously displayed photograph or picture 21 (i.e., adjacent the transparent front sheet 16 so that it is in view). Lastly, the user folds the side tab 12 back into a folded over position in order to re-secure the photographs or pictures 21, 24 within the front and rear pockets 22 and 23, respectively, of the photo sleeve portion 11.

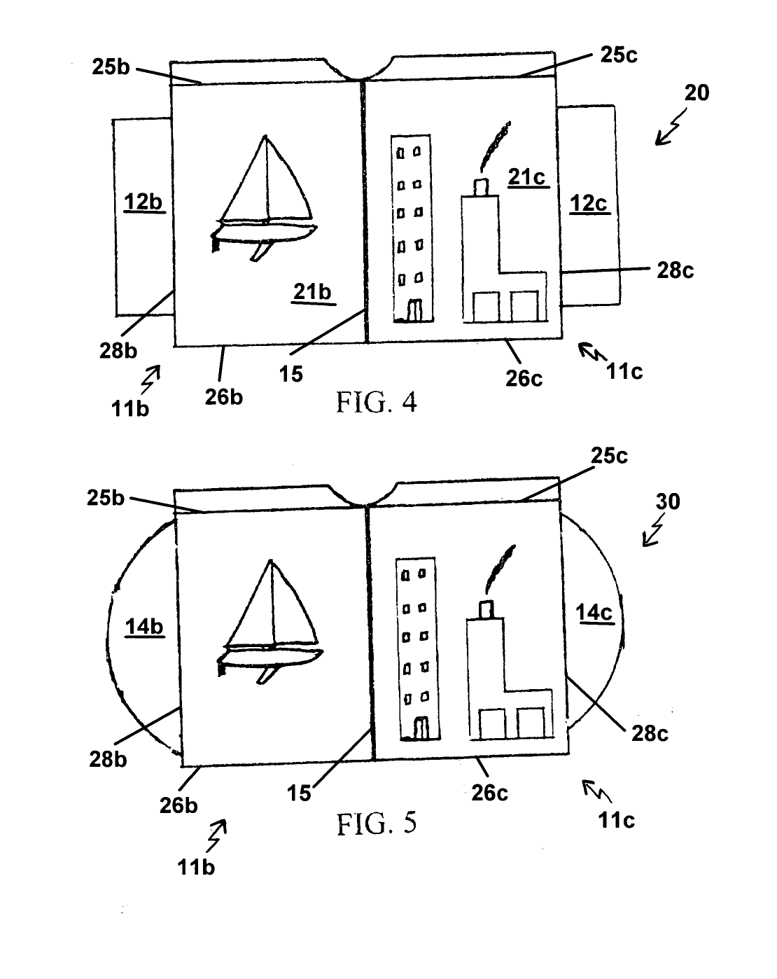

Alternate embodiments of the photo sleeve portion 20, 30 are depicted in FIGS. 4 and 5. The photo sleeve portions 20, 30 are each comprised of two, identical, mirror image, adjacent photo sleeves subsections, a left-side photo sleeve subsection 11b and a right-side photo sleeve subsection 11c. The left-side and right-side photo sleeve subsections 11b, 11c are both generally rectangular in shape and meet along a seal line 15, which extends along the transverse axis of the photo sleeve portion 20 or 30. Also, the left-side and right-side photo sleeve subsections 11b, 11c are sealed along bottom edges 26b, 26c and top edges 25b, 25c, and are open along diametrically opposite side edges 28b, 28c. The photo sleeve subsections 11b, 11c each comprise a transparent front sheet, an opaque dividing sheet, and a rear sheet forming a front pocket and a rear pocket, as described above.

The photo sleeve subsections 11b, 11c are equal in length. In a preferred embodiment of the present invention, the photo sleeve subsections 11b, 11c are also equal in width. For example, they may each accommodate at most a 2 inch×3 inch photograph or picture 21b or 21c. As another example, they may each accommodate at most a 5 inch×7 inch photograph or picture 21b or 21c. Of course, it is appreciated that the widths of the photo sleeve subsections 11b, 11c may be different, or that each photo sleeve subsection 11b, 11c may be subdivided into smaller, adjacent photo sleeve portions. Most desirably, the photo sleeve portion 11a, and subsections 11b, 11c, accommodate standard size photographs or pictures (e.g., 2″×3″, 3.5″×5″, 4″×6″, 5″×7″, and 8″×10″).

The photo sleeve portions 20, 30 may be constructed in a variety of ways. A single rear sheet, a single dividing sheet, and a single transparent front sheet may be joined along seam line 15 and edges 25b, 25c, 26b, 26c to form the left-side and right-side photo sleeve subsections 11b, 11c. Alternatively, two rear sheets, two dividing sheets, and two transparent front sheets may be joined along seam line 15 and edges 25b, 25c, 26b, 26c to form the left-side and right-side photo sleeve subsections 11b, 11c. Other alternatives include sealing the following combinations of sheets along seam line 15 and edges 25b, 25c, 26b, 26c to form the left-side and right-side photo sleeve subsections 11b, 11c:
(a) a single rear sheet, two dividing sheets, and two transparent front sheets;
(b) a single rear sheet, a single dividing sheet, and two transparent front sheets;
(c) two rear sheets, a single dividing sheet, and two transparent front sheets;
(d) two rear sheets, a single dividing sheet, and a single transparent front sheet;
(e) two rear sheets, two dividing sheets, and a single transparent front sheet; or
(f) a single rear sheet, two dividing sheets, and a single transparent front sheet.

In the embodiment 20 illustrated in FIG. 4, a left-side tab 12b projects from the rear sheet at the left-side open edge 28b of the photo sleeve subsection 11b, and a mirror-image, similarly sized right-side tab 12c projects from the rear sheet at the right-side open edge 28c of the photo sleeve subsection 11c. The side tabs 12b, 12c extend along nearly the entire length of the open edges 28b, 28c, respectively, and are generally rectangular in shape (see FIGS. 2 and 4). Other tab shapes are also suitable for use herein. Examples include tabs 12a, 12b, 12c that are generally semi-circular in shape, or generally triangular in shape. FIG. 5 illustrates generally semi-circular left-side and right-side tabs 14b, 14c, which are shown extending from open edges 28b, 28c.

The side tabs 12a, 12b, 12c, 14a, 14b may alternatively project from the transparent, front sheet 16, or the dividing sheet 17. Side tabs 12a, 12b, 12c, 14a, 14b may be continuous with the front sheet 16 or dividing sheet 17, provided that the front sheet 16 or dividing sheet 17 is transparent or may be separately adhered to the front sheet 16 or dividing sheet 17.

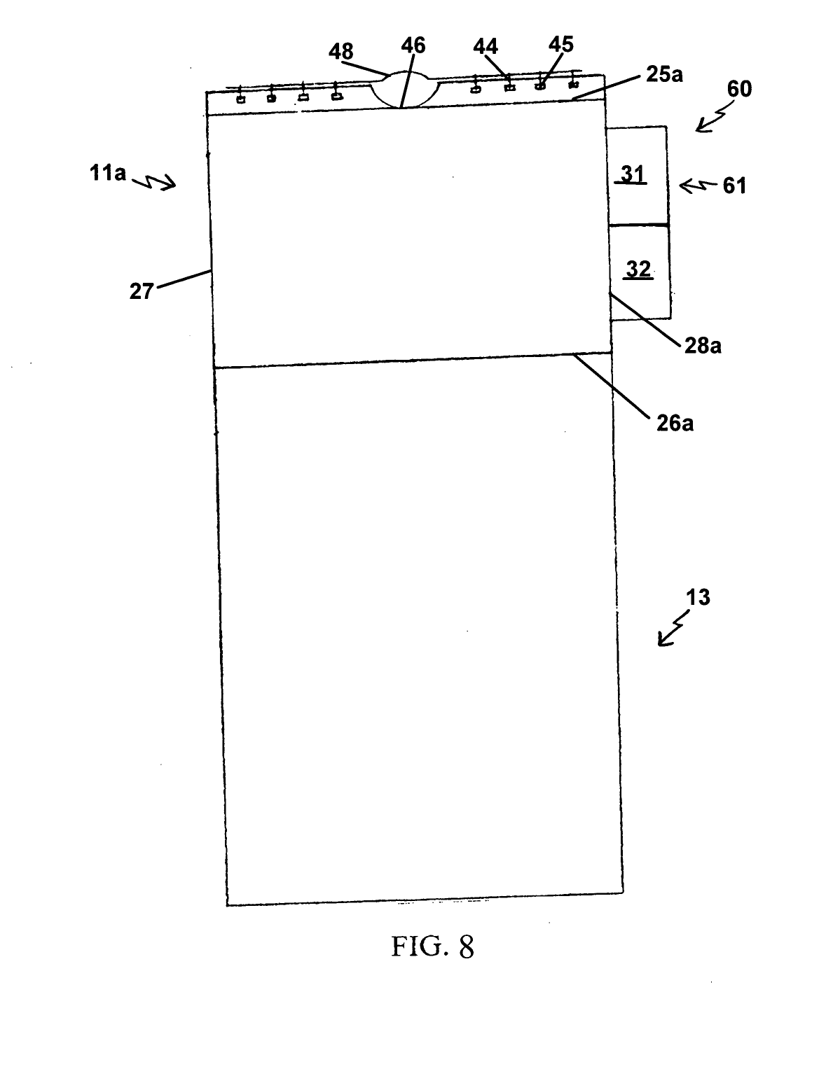

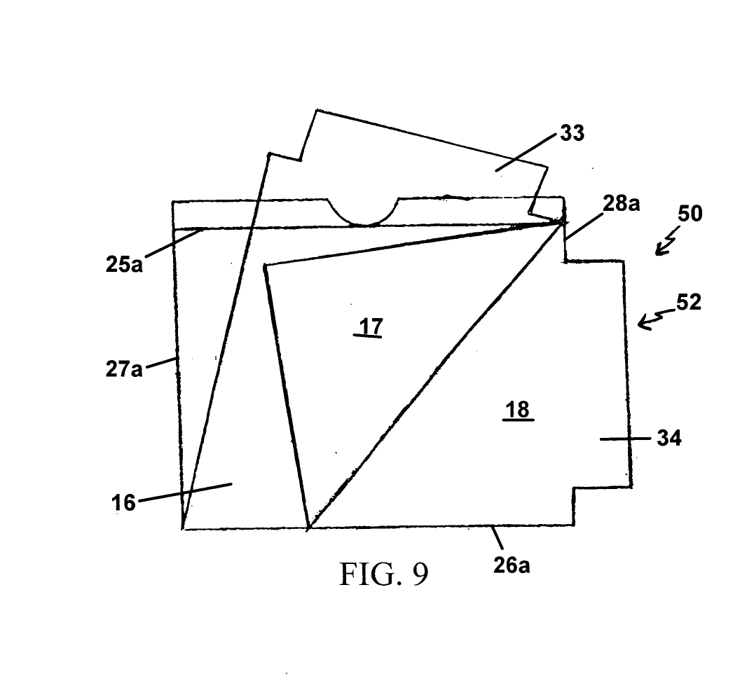

FIGS. 8 and 9 show two alternative embodiments 50, 60 with dual tabs 31-34. The dual tabs are advantageous because one of them may be folded forward, e.g., over a display photograph 21, and the other of them may be folded back, e.g., over photographs 24 to be stored. Alternatively, one dual tab section may folded forward over some photos/pictures 24 to be stored, and the other dual tab section may be folded back over other stored photos/pictures 24.

FIG. 8 shows an embodiment 60 with a split tab, in which a top split tab section 31 and an adjacent, bottom split tab section 32 project from the same open edge 28a, 28b, 28c of the dividing sheet 17. In use, the user folds one split tab section 31 or 32 backward at open edge 28a, 28b, 28c over the rear pocket 23 and stack of photographs or pictures 24 such that the split tab section 31 or 32 lies between the rearmost picture 24 and the rear sheet 18 and retains the photographs or pictures 24 within the rear pocket 23. The user folds the other split tab section 31 or 32 forward at open edge 28a, 28b, 28c over the front pocket 22 and the displayed photograph or picture 21 such that this split tab section 31 or 32 lies between the displayed photograph or picture 21 and the transparent, front sheet 16 and retains the photograph or picture 21 within the front pocket 22. Since cutting a tab during manufacture of a calendar device creates a split tab 61, the split tab 61 is also advantageous in that it is very inexpensive to manufacture.

The alternate embodiment 50 depicted in FIG. 9 includes a double tab 52 with a front tab section 33 of the double tab projecting from an open edge 28a, 28b, 28c of the transparent front sheet 16 and a rear tab section 34 of the double tab projecting from the same open edge 28a, 28b, 28c of the rear sheet 18. In FIG. 9, the layers of the photo sleeve are shown “peeled-away” for purposes of illustration. In use, the user folds the front tab section 33 backward at open edge 28a, 28b, 28c over the front pocket 22 and the displayed photograph or picture 21 such that the front tab section 33 lies between the displayed photograph or picture 21 and the dividing sheet 17 and retains the photograph or picture 21 within the front pocket 22. The user folds the rear tab section 34 forward at open edge 28a, 28b, 28c over the rear pocket 23 and the stored photographs or pictures 24 such that the rear tab section 34 lies between the front photograph or picture 24 and the dividing sheet 17 and retains the photographs or pictures 24 within the rear pocket. The double tab embodiment 50 is believed to allow firmer retention of multiple photographs/pictures within the photo sleeve.

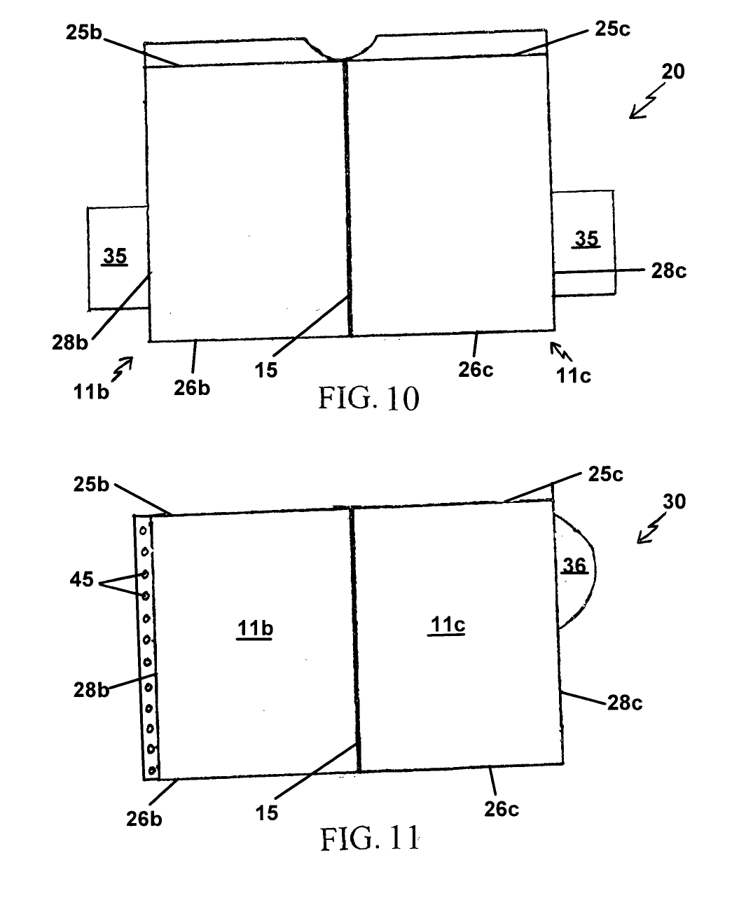

The single tabs 12a, 12b, 12c, 14a, 14b and the split tab sections 33, 34 need not extend nearly the entire length of open edges 28a, 28b, 28c; instead, they may extend only along a portion of the length of the open edges 28a, 28b, 28c. FIGS. 10 and 11 show two alternative short tabs 35 (upper), 36 (lower).

The embodiment 20 depicted in FIG. 10 includes lower tabs 35, which extend from an open edge 28a, 28b, 28c of the transparent front sheet 16, dividing sheet 17, or rear sheet 18 at the lower end of the sheet. A lower tab 35 is advantageous in that it provides security at the bottom of the photographs/pictures, where they are more likely to fall out of the photo sleeve as the calendar is handled.

Similarly, FIG. 11 shows an embodiment 30 having an upper tab 36, which extends from an open edge 28c of the transparent, front sheet 16, dividing sheet 17, or rear sheet 18 at the upper end of the sheet. This upper tab configuration is advantageous in a calendar device that is bound along one side, as shown in FIG. 11, rather than at the top (see FIG. 10). The upper tab secures the photos near the top of the photos, where they would otherwise be more likely to be flung out of the photo sleeve as the calendar pages are turned. There need only be one tab in this embodiment 30, since the rings that will extend through the binding apertures 45 will largely prevent the photographs/pictures in the left-side photo sleeve subsection 11b from exiting the photo sleeve.

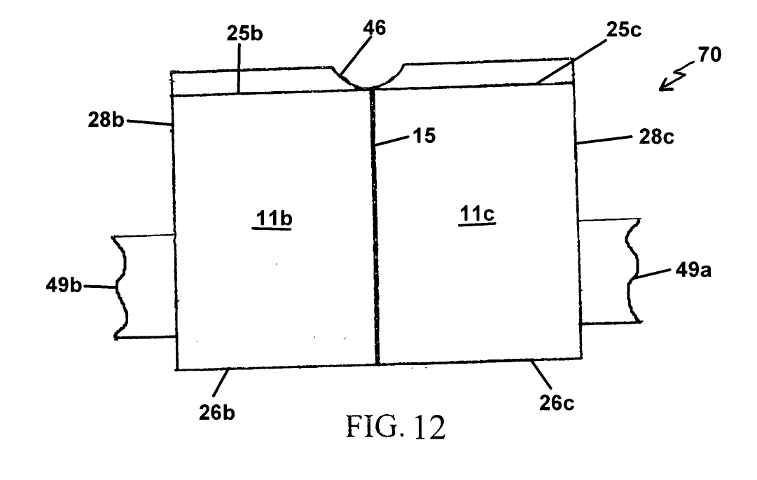

Additionally, the tabs 12a, 12b, 12c, 14a, 14b, 14c, 33, 34, 35, 36 may comprise at least one irregular or nonlinear tab edge 49, as found in the nonlinear tab edge embodiment 70 of FIG. 12. By “nonlinear tab edge” is meant that the edge of the tab, particularly the farthest edge from the photo sleeve, is not straight. The tab edge can be serpentine in shape 49a, as shown in FIG. 12, or serrated 49b or otherwise jagged in shape, for example. Tabs with all smooth (linear) edges tend to lie flatter against the sheets 16, 17, 18 and adhere to the photographs or pictures 21, 24 versus tabs having a nonlinear edge 49. In contrast, nonlinear tab edges 49 facilitate removal of the tabs from between the photo sleeve sheets 16, 17, 18 and the photographs or pictures 21, 24. Also, the user can more readily grip a tab having an irregular, nonlinear edge 49 as shown in FIG. 12 than a tab having a smooth, linear edges, like the tabs 35, 36 depicted in FIGS. 10 and 11.

Photograph-safe adhesive 51 on the front and/or back faces of the tabs 12a, 12b, 12c, 14a, 14b, 14c, 33, 34, 35, 36 further ensures that the tabs remain in their folded position, retaining the photographs or pictures 21, 24 within the pockets 22, 23. The adhesive 51 detaches from the sheets 16, 17, 18 and photographs or pictures 21, 24 when the user pulls the tabs away from the sheets, photographs, or pictures. The tabs then reattach to the sheets, photographs or pictures when the adhesive 51 is again put in contact with the sheets, photographs, or pictures (when the user presses the tabs against the sheets, photographs, or pictures).

Returning to FIG. 1, the calendar device 10 is preferably comprised of a series of calendar sheets 37, with each calendar sheet 37 comprising a photo sleeve subsection 11a, 11b, 11c and a calendar portion 13. A monthly calendar 38 (a portion of which is depicted in FIG. 1) is printed on the calendar portion 13. The monthly calendar preferably includes a month name 39 (e.g., April), month numerical days 40 (e.g., 1, 2, 3), and blank spaces 41 adjacent to each numerical day in which a user may write notes to remind him/her of special occasions (e.g., birthdays and anniversaries).

The calendar device 10 may present any type of calendar and may comprise any number of calendar sheets. The present invention is not limited to a calendar portion 13 divided into months, as shown in FIGS. 1 and 2. Other calendars that may be printed on the calendar portion 13 are a daily calendar, a weekly calendar, and a yearly calendar. The calendar device may have sheets that can be torn off as each month ends and disposed of; however, the calendar device 10 is preferably perpetual in that it can be reused every year until the material it is made of wears out. Therefore, the calendar portion preferably does not include a year marking (e.g., “2005”). The twelve pages, or six pages printed front and back, of the calendar device 10 each include a month of the year and either 28, 29, 30, or 31 blank spaces 41.

In the preferred embodiment of the calendar device 10, the user displays photographs or pictures 21 in the photo sleeve portion 11a, 20, 30 to remind him or her of important occasions for that month. Each month, the user notes special occasions in the blank space 41 corresponding to the numerical day 40 of the month on which the special occasion occurs. Then the user displays photographs or pictures 21 that relate to at least one of the special occasions. For example, the user may make note a relative's birthday in the blank space 41 corresponding to January 25 and concurrently display a photograph 21 of that relative to remind the user of the relative's birthday. The user may also utilize the calendar device 10 to remind him or her of appointments (e.g., doctor and dentist appointments) other activities (e.g., sporting or school events) occurring during a particular month. For example, the user may make note a dental appointment in the blank space 41 corresponding to April 5 and concurrently display a picture 21 of a dentist or teeth to remind him/her of his/her impending dentist appointment. If desired, the calendar device 10, 20, 30, 50, 60, 70 may have a theme, such as a monthly diet reminder or cookbook with healthy food photographs or pictures of recipes displayed in the photo sleeve.

Since the photographs/pictures can be rotated quickly and easily, the user is less likely to be bored by the displayed photograph 21 and thus finds the calendar device 10, 20, 30, 50, 60, 70 visually attractive. This means that the user is more likely to remember the birthday or other event he or she wishes to remember. A sheet of small, removable paper or plastic shapes with adhesive on a lower face (not shown) can be provided at the end of the calendar device 10, 20, 30, 50, 60, 70. The shapes can be removed and placed directly on the displayed photo or on the transparent front sheet 16 over the photograph 21. For example, a birthday hat or birthday cake shape can be placed over the head or in the hands of the birthday boy or girl in the photo. The adhesive is removable and does not damage the photo.

With continued attention to FIG. 1, in its preferred embodiment, the calendar device 10 is further comprised of at least twelve (12) calendar sheets 37, each bearing a monthly calendar 38 for a different month. Binding 42 extending through a binding area 43 extending above the photo sleeve portion 11a, 20, 30 permits the user to flip between calendar sheets 37. The binding 42 joins the calendar sheets 37, so that the user may flip between calendar sheets 37. The binding 42 preferably includes a number of rings 44, which extend through a like number of binding apertures 45 positioned leftward and rightward of a central notch 46 in the binding area 43. The calendar device preferably further includes a hanger 47, which extends through the rings 44 and is generally linear except for a central, bowed segment 48 above the notch 46.

The calendar device 10 is also versatile in that it may be utilized as a desk-top type calendar or a wall calendar, for example. Advantageously, the notch 46 in the binding area 43 provides clearance for the bowed segment 48 when a user flips between calendar sheets 37. Also due to the notch 46 and binding 42, the user may rotatably invert the calendar sheets 37 to view calendar sheets 37 below the top calendar sheet without removing the calendar device 10 from the wall or other substantially vertically oriented surface, if the calendar device 10 is hung on such a surface. The hanger 47 is also preferably removably insertable through the rings 44, so that it may be removed if the user desires to utilize the calendar as a desktop-type calendar. The calendar device is lightweight enough to be hung on a magnetic hook on any suitable surface, such as the front or side of a refrigerator. The photo sleeve portion 11 and the calendar portion 13 are preferably substantially on the same plane, with the calendar portion below the photo sleeve portion, so the calendar device 10 can be laid flat on a desk or table.

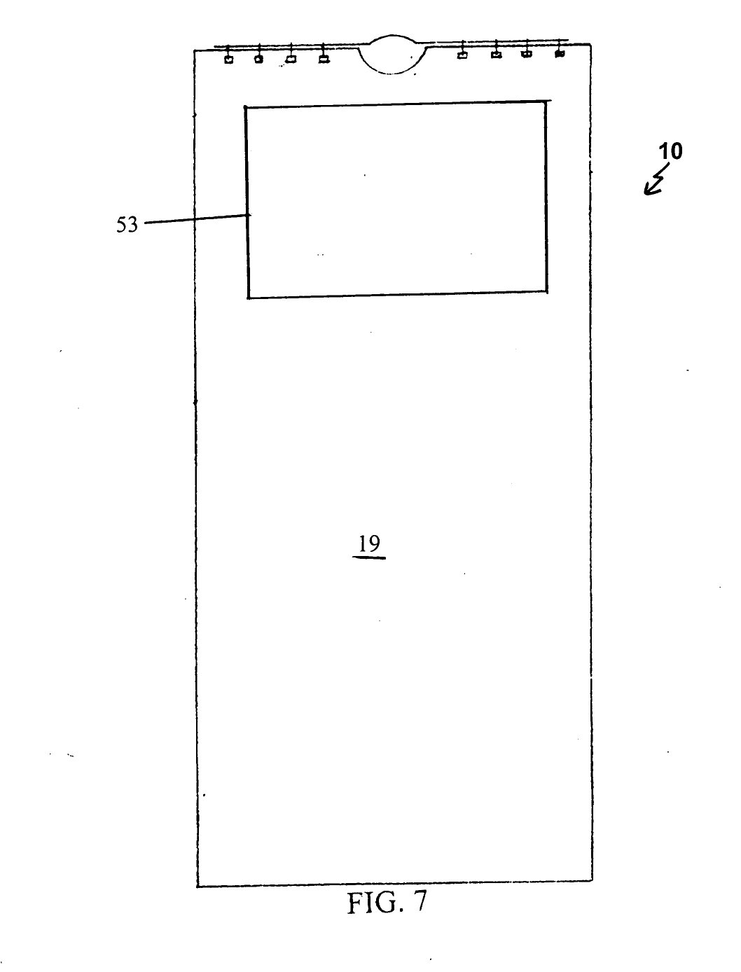

A cover 19, as illustrated in FIG. 7, may also be bound with the calendar sheets 37. The cover 19 preferably includes a cut-out 53 at the top to permit potential buyers to view the stock photo on the next month's page. This provides a better understanding of the calendar device product once it is packaged and sealed in clear wrap. The cut-out 53 also allows the user who purchases the calendar device to view the photo he or she has inserted on the following (next month's) page, even when the cover 19 is closed.

A reusable, alternative embodiment of the calendar device 10 comprises a single, reusable calendar sheet having a reusable, calendar portion 13 adjacent to the photo sleeve portion 11 described hereinabove. For example, the reusable, calendar portion 13 may be an erasable white board or an erasable chalk board. The reusable, calendar portion 13 may include any type of reusable calendar printed thereon, such as a daily calendar, a weekly calendar, a monthly calendar, or a yearly calendar. If the reusable calendar is a monthly calendar 38, the month name can be omitted from the calendar. Instead, to identify the month, the user removably writes a desired month name in a designated area of the calendar portion 13. Also, to facilitate reuse, the numerical days 40 are consecutive numerical days 1 through 31, so that the reusable, monthly calendar 38 has sufficient numerical days for each month of the year (e.g., April has 30 days, while July has 31 days).

From the foregoing it can be realized that the described device of the present invention may be easily and conveniently utilized as a calendar device for displaying and storing at least one photograph or picture and prompting a user's memory to remember important events. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 calendar device

11a photo sleeve portion

11b left-side photo sleeve subsection

11c right-side photo sleeve subsection

12a-d side tab

13 calendar portion

14 semi-circular shaped tab

15 seam line

16 front sheet

17 dividing sheet

18 rear sheet

19 cover

20 alternate embodiment

21 displayed photograph or picture

22 front pocket

23 rear pocket

24 stored photographs or pictures

25a-c top edges

26a-c bottom edge

27 side edge

28a-c open side edges

29 upper end

30 second alternate embodiment

31 top split tab section

32 bottom split tab section

33 front tab portion

34 rear tab portion

35 lower tab

36 upper tab

37 calendar sheet

38 monthly calendar

39 month name

40 numerical day

41 blank space

42 binding

43 binding area

44 rings

45 binding aperture

46 notch

47 hanger

48 bowed segment

49 nonlinear tab edge

50 double tab embodiment

51 adhesive

52 double tab

53 cut-out in cover

60 split tab embodiment

61 split tab

70 nonlinear tab embodiment

1. A calendar device for storing and displaying interchangeable photographs or pictures, and reminding a user of important events, the calendar device comprising:
(a) a photo sleeve portion comprising at least one reusable, re-foldable tab for retaining the photographs or pictures in the photo sleeve portion; and
(b) a calendar portion adjacent to the photo sleeve portion;
wherein the photo sleeve portion holds at least one photograph or picture.

2. The calendar device according to claim 1, wherein the photo sleeve portion comprises a front sheet and a rear sheet, the front sheet overlaying the rear sheet and being substantially transparent, the at least one photograph or picture being removably insertable between the front sheet and the rear sheet.

3. The calendar device according to claim 2, wherein the at least one foldable tab extends from the front sheet.

4. The calendar device according to claim 2, wherein the at least one foldable tab extends from the rear sheet.

5. The calendar device according to claim 2, wherein the photo sleeve portion is generally rectangular in shape, the photo sleeve portion further comprises a top edge and a bottom edge, the front sheet and the rear sheet being joined along the top edge and the bottom edge, and the top edge being substantially parallel to and spaced apart from the bottom edge.

6. The calendar device according to claim 5, wherein the photo sleeve portion further comprises a dividing sheet between the front sheet and the rear sheet, a front pocket between the front sheet and the dividing sheet, and a rear pocket between the dividing sheet and the rear sheet, and wherein the dividing sheet is joined along the top edge and the bottom edge to the front sheet and the rear sheet.

7. The calendar device according to claim 6, wherein the at least one foldable tab extends from the dividing sheet, the dividing sheet being substantially opaque or colored.

8. The calendar device according to claim 6, wherein the at least one foldable tab is a split tab, the split tab comprising a top split tab section and the bottom split tab section, the top split tab section being adjacent to, longitudinally oriented to, and directly above the bottom split tab section.

9. The calendar device according to claim 6, wherein the at least one foldable tab is a double tab, the double tab comprising a front tab section and a rear tab section, the front tab section extending from the front sheet along the first or second side edge, and the rear tab section extending from the rear sheet along the same first or second side edge.

10. The calendar device according to claim 5, wherein the photo sleeve portion further comprises a first side edge and a second side edge, the first side edge being substantially parallel to and spaced apart from the second side edge, the first and second side edges being substantially perpendicular to the top edge and the bottom edge.

11. The calendar device according to claim 2, wherein the at least one foldable tab is a lower tab, the lower tab extending from the photo sleeve portion along the bottom end of the photo sleeve portion.

12. The calendar device according to claim 2, wherein the at least one foldable tab is an upper tab, the upper tab extending from the photo sleeve portion along the top end of the photo sleeve portion.

13. The calendar device according to claim 2, wherein the at least one foldable tab further comprises at least one nonlinear edge.

14. The calendar device according to claim 3, wherein the at least one foldable tab further comprises at least one serrated edge.

15. The calendar device according to claim 10, wherein the photo sleeve portion is not sealed along the first and second side edges.

16. The calendar device according to claim 15, wherein the photo sleeve portion further comprises at least two photo sleeve subsections separated from each other by at least one seal line.

17. The calendar device according to claim 16, wherein the at least two photo sleeve subsections are a left-side photo sleeve subsection and a right-side photo sleeve subsection, and wherein the at least one foldable tab is a left-side tab and a right-side tab, the left-side tab extending from the left-side photo sleeve subsection along the first side edge, the right-side tab extending from the right-side photo sleeve subsection along the second side edge, the at least one photograph or picture being at least one first photograph or picture and at least one second photograph or picture, the at least one first photograph or picture being removably insertable in the left-side photo sleeve subsection, and the at least one second photograph or picture being removably insertable in the right-side photo sleeve subsection.

18. The calendar device according to claim 1, wherein the calendar portion comprises a monthly calendar, the monthly calendar comprising six or twelve pages, each page comprising between 28 and 31 blank spaces, each blank space corresponding to a day of a month.

19. The calendar device according to claim 18, wherein the monthly calendar further comprises a plurality of consecutive, numerical days, each numerical day corresponding to a blank space, and wherein each of the month pages comprises a month name, the monthly calendar being without a year marking; and wherein the photo sleeve portion and the calendar portion are substantially on the same plane.

20. The calendar device according to claim 1, wherein the at least one foldable tab comprises an adhesive on at least one face, the adhesive tab being removably attachable to a side of the photograph or picture.

21. The calendar device according to claim 2, wherein the at least one foldable tab is generally semi-circular in shape.

22. The calendar device according to claim 2, wherein at least one edge of the side tab is serpentine in shape.
